(19) United States
(12) Patent Application Publication
(10) Pub. No.: US 2026/0284866 A1
(43) Pub. Date: Sep. 24, 2026

(54) NON-RIGID, DEFORMABLE ROBOTIC BODY

(71) Applicant: Worcester Polytechnic Institute, Worcester, MA (US)

(72) Inventors: Cagdas D. Onal, Natick, MA (US); Abudula Aihaitijiang, Worcester, MA (US); Robin Hall, North Smithfield, RI (US); Timothy Jones, Worcester, MA (US)

(21) Appl. No.: 19/570,774

(22) Filed: Mar. 18, 2026

Related U.S. Application Data
(60) Provisional application No. 63/773,781, filed on Mar. 18, 2025.

(51) Int. Cl. B25J 9/06; B25J 9/00; B25J 9/14

(52) U.S. Cl. CPC B25J 9/065; B25J 9/0015; B25J 9/142

(57) ABSTRACT

A flexible robotic body imparts efficiency and elegance to motive activities. Movement of a central, elongated body, flanked by elements or limbs with actuated members, provides mobility and direction based on bending or oscillating movement of the elongated body. Propellors, wheels or control surfaces extending from the elongated body complement arcuate or pivotal movement of the elongated body. A plurality of generally planar segments, arranged in parallel and normal to a central axis, are joined by linkages aligned with the axis. The linkages may be circumferential, bending surfaces, or central pivot points formed from deformable material along the axis. Linear or tethered actuators configured for extension or compression along three lines parallel to the central axis allow three-dimensional orientation through selective extension and/or compression along the three lines. Three motive actuators can therefore orient the elongated body rather than a conventional interconnection of rigid pivoting and rotating joints.

### RELATED APPLICATIONS

This patent application claims the benefit under 35 U.S.C. § 119(e) of U.S. Provisional Patent App. No. 63/773,781, filed Mar. 18, 2025, entitled “SOFT AERIAL ROBOT,” incorporated herein by reference in entirety.

### STATEMENT OF FEDERALLY SPONSORED RESEARCH AND DEVELOPMENT

This Invention was made with Government support under contract No. CMMI-1752195, awarded by the National Science Foundation (NSF). The Government has certain rights in the Invention.

### BACKGROUND

Robotics are continually becoming more integrated into manual tasks previously performed by human actions such as grasping and holding objects. Robotic elements are typically constructed of rigid materials to provide sufficient strength and structural integrity. Robotic actuation often involves rigid movable, driven members and corresponding axial, pivoting or articulated joints having sufficient mass to withstand the actuated forces.

### SUMMARY

A flexible robotic body imparts efficiency and elegance to motive activities. Movement of a central, elongated body, flanked by elements or limbs with actuated members, provides mobility and direction based on bending or oscillating movement of the elongated body. Propellors, wheels or control surfaces extending from the elongated body complement arcuate or pivotal movement of the elongated body. A plurality of generally planar segments, arranged in parallel and normal to a central axis, are joined by linkages aligned with the axis. The linkages may be circumferential, bending surfaces as in an origami structure, or central hinges or pivot points formed from deformable material along the axis. Linear or tethered actuators configured for extension or compression along three lines parallel to the central axis allow three-dimensional orientation through selective extension and/or compression along the three lines. Three motive actuators can therefore orient the elongated body rather than a conventional interconnection of rigid pivoting and rotating joints.

Configurations herein are based, in part, on the observation that conventional robots typically employ a rigid frame, with actuated members or end effectors pivotally or rotationally mounted to the rigid frame, and/or forming a part of the rigid frame through mechanically articulated joints. Unfortunately, these conventional approaches suffer from the shortcoming that substantial mass and material composition is employed for the load bearing members and joints, increasing weight, decreasing mobility and requiring more energy for movement. The result is a dense structure requiring additional mass for electrical, hydraulic or pneumatic pumps, motors and servos for imparting movement.

Accordingly, configurations herein substantially overcome the shortcomings of conventional, heavy and rigid robotic frames by providing a continuous, deformable robotic structure defining an elongated body. The continuous structure may take the form of a folded, tubular planar material, a homogenous, elongated flexible foam, or a rubber/polymer structure. The continuous structure is formed from a flexible material and configured for a continuum of bendable movement along its length. Actuators and motive appendages may extend from the deformable frame structure defining the body or frame, however the elongated body may be deformed in any direction in a 3-dimensional space from three tethers or extensors extending parallel and offset from a central axis through the body.

In further detail, a robotic device includes a plurality of cross sectional segments, where the cross sectional segments are aligned along a central axis, and each cross sectional segment of the plurality of cross sectional segments has a flexible linkage to an adjacent cross sectional segment. A plurality of antagonistic members such as tethers or actuators extend through the cross sectional segments at a parallel offset to the central axis, such that the antagonistic members are each configured for extension or contraction. An actuation source such as electric, pneumatic or hydraulic drives the antagonistic members in independent movement, such that the actuated movement of one or more of the antagonistic members disposing the cross sectional segments out of a parallel alignment where the angular orientation between adjacent segments aggregates to a bend or curve in an elongated body defined by the sequence of segments.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side schematic view of an elongated body suitable for use with robotic configurations herein;

FIGS. 2A-2D show formation of the elongated body of FIG. 1;

FIGS. 3A-3C show exploded and perspective views of the elongated body of FIG. 1;

FIGS. 4A-4B show an example of a hollow, tubular configuration of the elongated body in an aerial robot example application;

FIGS. 5A-5D show perspective views of the robot of FIGS. 4A-4B in task based configurations; and

FIGS. 6A-6B shows diagrams of the control mechanisms in the robot of FIGS. 4A-5D.

### DETAILED DESCRIPTION

Depicted below are example configurations of a flexible or deformable elongated robotic body in a tubular, hinged foam or pivoting resilient material construction with linear tethers and actuators for extension and retraction adjacent a central axis for flexible movement in a 3-dimensional (3-D) space.

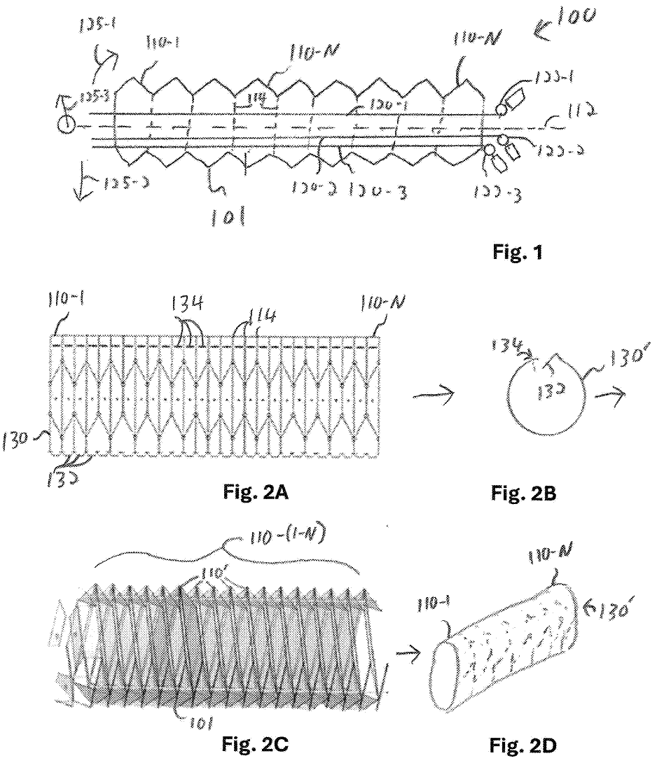

FIG. 1 is a side schematic view of an elongated body suitable for use with robotic configurations herein. Referring to FIG. 1, the disclosed approach provides a robotic device 100, defined by an elongated body 101 having a plurality of cross sectional segments 110-1 . . . 110-N (110 generally), where the cross sectional segments 110 align along a central axis 112, and each cross sectional segment 110-N of the plurality of cross sectional segments has a flexible linkage 114 such as a folding seam to an adjacent cross sectional segment 110-N(+/−1). Each of the cross sectional segments are planar polygonal or circular in form, typically although not necessarily of the same size and dimensions. An outer tubular construction or flexible inner hinge/joint construction allows the elongated body to flex and bend along its length, discussed further below. The segments and linkages may be of any suitable size and ratio, such that the linkages may enlarge to form a straight sided or continuous volume of hollow or solid homogeneous flexible construction. A suitable non-rigid body selectively actuatable by the antagonistic members provides the disclosed advantages.

A plurality of antagonistic members 120-1 . . . 120-3 (120 generally) extend through each of the cross sectional segments 110 at a parallel offset to the central axis 112, such that the antagonistic members 120 are configured for extension or contraction. An actuation source 122-1 . . . 122-3 drives the antagonistic members 120 for independent movement, such that the actuated movement of one or more of the antagonistic members 120 disposes the cross sectional segments 110 out of a parallel alignment for imparting a curve or bend to the elongated body 101, as shown by arrows 125-1 . . . 125-3, corresponding to horizontal, vertical and elevation (z-axis) movement, or any combination thereof.

By having at least three antagonistic members 120, such as tethers, extending through and adjacent to the central axis 112, and oriented at equilateral distances around the axis 112, retraction of one of the members 120 by the corresponding actuator 122 (such as a spool driven by a servo), the elongated body 101 will tend to be pulled in the direction of compressing distance between the cross sectional segments.

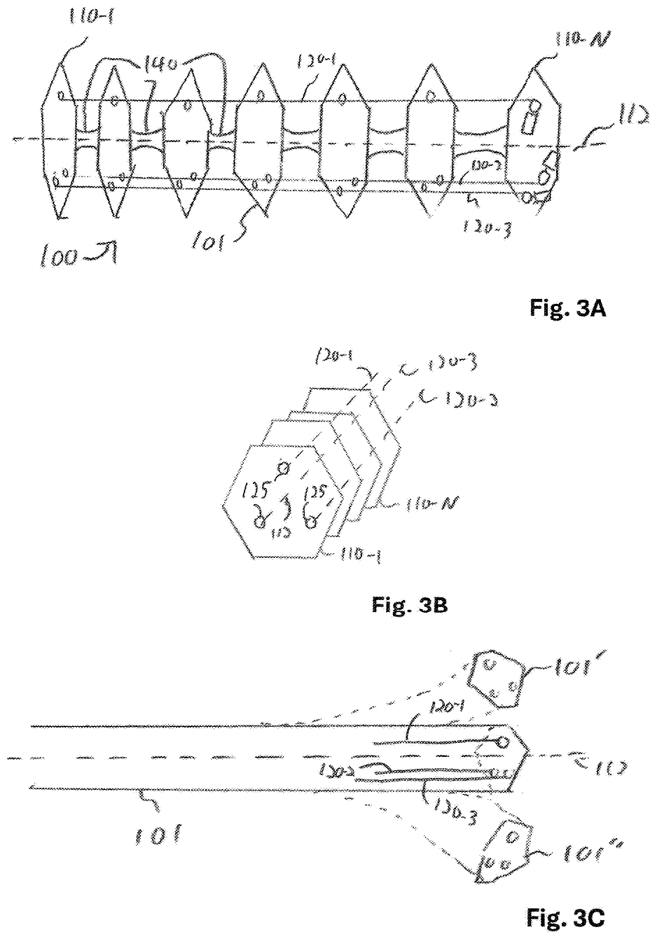

FIGS. 2A-2D show formation of the elongated body of FIG. 1. Referring to FIGS. 1-2D, FIG. 2A sows the cross sectional segments 110 defined by a planar shape, each planar shape parallel to the planar shape of the others of the plurality of cross sectional segments at a rest (uncurved/non-bending) position, such that the series of parallel planar shapes define the elongated body 101. In an example configuration, the cross sectional segments 110 form a hollow, tubular circumference, such that the segments 110 are defined by folds between adjacent cross sectional segments, and the folds forming a continuous tubular structure defining an elongated body.

FIG. 2A shows a crease pattern formed in a planar sheet material 130. Each of the segments 110 includes a tab 132 adapted to engage a slot 134 when formed into a tubular shape as in FIG. 2B. The resulting tubular shape 130′ forms ridges 110′ from the creases of each segment 110 for bending, compressing or elongating the body 101. Techniques of so-called “origami” paper folding may be incorporated in formation of the tubular shape 130′ form.

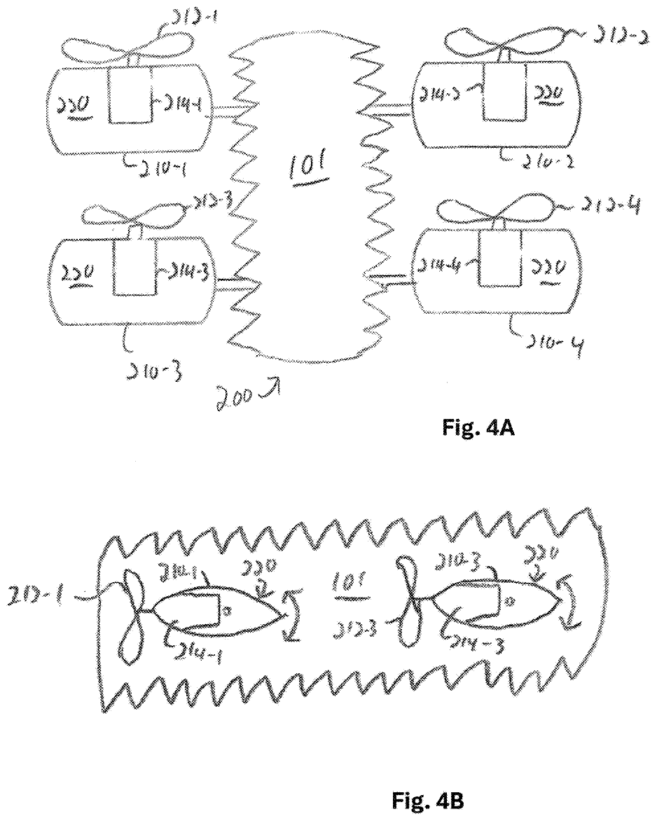

FIGS. 3A-3C show exploded and perspective views of the elongated body of FIG. 1. Referring to FIGS. 1-3C, FIG. 3A shows an expanded view of the elongated body 101 with planar segments 110 having a central linkage 140, rather than perimeter folds as ridges 110.′ The cross sectional segments 110 are each defined by a resilient material and the flexible linkage 140 defined by a protrusion of the resilient material. The planar segments 110 are polygonal or circular and therefore include a pivotal linkage between each of the cross sectional segments 110 and an adjacent cross sectional segment 110-(+/−1), such that each of the linkages is aligned with the central axis 112 in a rest position. Each segment 110 is defined from a planar shape of a foam, plastic/polymer or rubber material of a resilient and flexible quality. FIG. 3B shows a perspective view of how the antagonistic members 120 extend through orifices 125 in the series of segments 110, roughly at a circumferential offset to form an equilateral triangle. FIG. 3C shows a homogeneous, straight-sided unsegmented body for depicting how unequal movement of the antagonistic members 120 forms an arcuate shape of the elongated body and offset from the central axis 112, as a shortened tether 120-1 tends to “pull” the elongated body 101 into position 101,′ while a lengthened member 120-1 can tend to “push the elongated body 201 into position 101.” Complementary tensioning/retraction of antagonistic members 120-2 and 120-3 have a similar effect to form the bend 101”. Various combinations of extension and contraction of the antagonistic members 120, whether rigid or flexible tethers, may be employed.

In an example configuration, the antagonistic members 120 may be defined by tethers responsive to a motive rotational retraction for compressing the elongated body along the respective tether. Alternatively, the antagonistic members 120 may be fluidic vessels or linear actuators responsive to a pressure source for extending the elongated body along the respective vessel. For any suitable implementation of the antagonistic members 120, extension of the antagonistic members 120 in an equal amount increases a length of the elongated body 101 while maintaining alignment with the central axis 112, as when all 3 (or more) extend in parallel. Conversely, contraction of the antagonistic members 120 in an equal amount decreases a length of the elongated body 101 while maintaining alignment with the central axis 112. Such contraction may be invoked for imparting a gripping force to an engaged object.

The elongated body 101 is suitable for a wide range of robotic implementations. Movement imparted through bending, deformation and/or flexure of the elongated body, coupled with appendages, limbs or end-effectors extending therefrom, define an efficient and useful platform for robotic endeavors for land, aquatic and/or airborne uses.

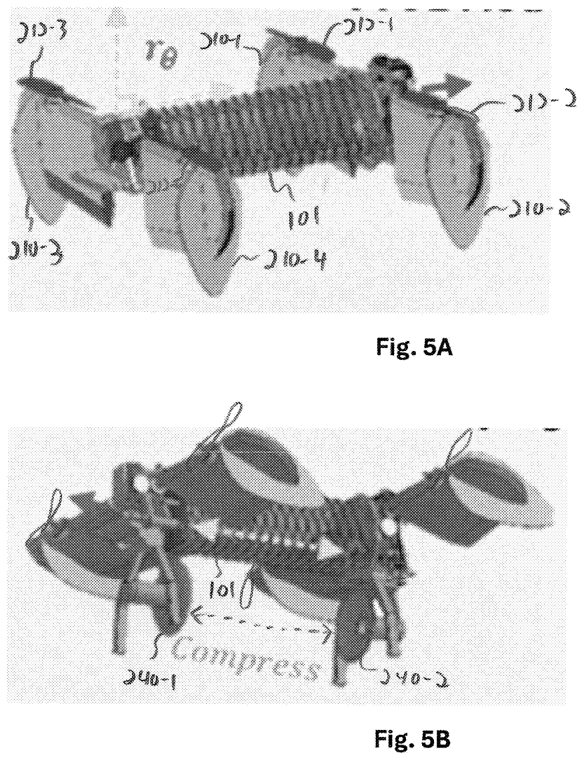

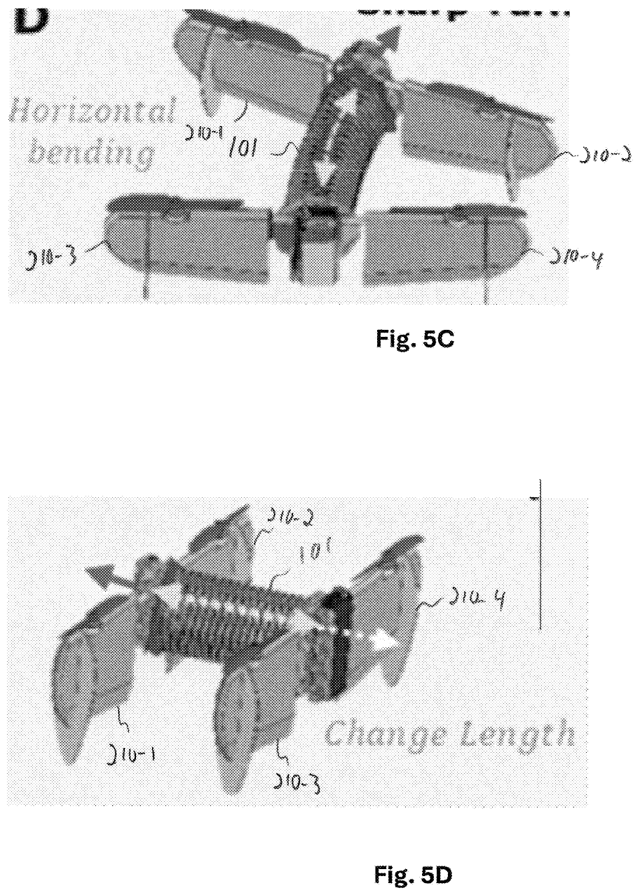

In an example configuration, the lightweight tubular structure provides a suitable form factor for a soft-bodied aerial robot configuration. FIGS. 4A-4B show an example of a hollow, tubular configuration of the elongated body in an aerial robot example application. Referring to FIGS. 4A-4B, a “soft,” deformable aerial robot employs a deformable fuselage and methods to deform their fuselage to achieve high-performance, fixed-wing flight. Body morphing is commonly used in nature for mobility and maneuverability. However, conventional approaches to aerial robotics research has not explored the use of a morphing fuselage to control flight. Current winged aerial robots have complex control systems with multiple distinct control surfaces, but may lack the ability to adapt to different flight conditions and tasks, which may require high maneuverability and sharp turns. The underexplored morphable fuselage is expected to play an important role in achieving high maneuverability and agility in fixed-wing aerial robots. The configuration of FIGS. 4A-5C describe an origami-inspired morphing fuselage strategy to improve the agility, turn maneuverability, and extended fixed-wing flight capabilities of a new class of flight platform called soft aerial robot (SoAR) using a simple flight control algorithm and without traditional control surfaces. The disclosed approach demonstrates that SoAR can extend flight capabilities by simply changing its body bending curvature in the horizontal and vertical planes during flight. Horizontal bending of the fuselage results in a rapid sharp-turn maneuver; this method replaces yaw control surfaces in conventional aircraft.

Vertical up-bending of the fuselage results in aggressive pull-up flight capabilities and a unique emergency brake maneuver. The proposed morphing-fuselage soft aerial robot not only extends flight capabilities, but also enables the grasping and delivery of objects by changing the length of its deformable fuselage without the need for additional actuators. Finally, the deformable structure of the fuselage helps absorb external forces to protect the aerial robot from collisions. Configurations herein demonstrate how a soft body can increase performance in fixed-wing horizontal flight, including high maneuverability, and flight agility of aerial robots. The demonstrated unique design and experimental results illustrate the new capabilities enabled by these next-generation agile soft aerial robots.

Referring to FIGS. 4A-4B, the aerial robot 200 includes one or more robotic members 210-1 . . . 210-4 (210 generally) extending from the elongated body 101, such that each of the robotic members 210 has a motor unit 214-1 . . . 214-4 (214 generally) configured for propulsion of the elongated body 101 via a respective propeller 212-1 . . . 212-4 (212 generally). By extending one or more robotic members 210 from the elongated body 101, each of the robotic members 210 exhibits a corresponding control surface 220 or wing configured for fluidic engagement and directional control of the elongated body 101. The motor units 214 and rotary connection to the propeller 212 each define a motive source connected to the elongated body 101, such that the motive source is configured for propulsion of the elongated body in a direction based on the extension or retraction of the antagonistic members 120.

The engagement of the robotic members with the elongated body is facilitated by the torsional rigidity of the elongated body. The tubular form allows for axial (lengthwise) and bending (side to side) flexure, but resists torsional movement that can compromise or cancel the propulsion directed movement and directional control.

The movable flight control surfaces 220 increase flight capabilities by simply changing body bending curvature in the horizontal and vertical planes during flight. By employing the morphing body approach, soft aerial robots can improve flight performance including high-maneuverability sharp turns, and aggressive flight capabilities. Flight capabilities of the proposed soft aerial robot may be evaluated during fixed-wing horizontal flight in different body morphing configurations. The experimental method consists of tests with horizontal bending, vertical up-bending, and a compressed body (changing the fuselage length). In these experiments, fuselage horizontal bending results in highly maneuverable low-radius turns and immediate sharp turn capability, and vertical fuselage up-bending results in pull-up aggressive flight and an emergency braking maneuver. In addition to the stated benefits in maneuverability, the proposed soft aerial robot also enables the grasping and delivery of payloads by compressing its deformable fuselage between extended protrusions.

FIGS. 5A-5D show perspective views of the robot of FIGS. 4A-4B in task-based configurations. FIG. 5A shows combined features of fixed-wing and rotary-wing aircraft features in one quad tilt wing soft aerial robot. The tilt-wing strategy enables VTOL capabilities for ease of taking off and landing, while the approach of FIG. 5A demonstrates the use of a morphing fuselage (body 101) during fixed wing horizontal flight, which increases flight range and energy efficiency. The morphing fuselage replaces traditional control surfaces and offers aggressive flight capabilities in horizontal fixed-wing flight mode. Capabilities include controllable turns, sharp turns with near zero radius of curvature, and pull-up maneuvers that result in multiple outcomes such as an Immelmann turn, back flip, and a unique emergency brake maneuver.

FIG. 5B shows a grasping capability by contracting each of the antagonistic members 120 for forming a linear compression of the elongated body 101. Opposed grasping plates 240-1 . . . 240-2 compress together for grasping a payload or object. FIG. 5C shows bending movement to the elongated body 101 for orienting the control surfaces 220 of the robotic members 210, effecting directional control in absence of a stabilizer, flaps or rudder as in conventional aircraft. FIG. 5D illustrates compression and elongation of the elongated body 101 by uniform extension and retraction of the antagonistic members 120.

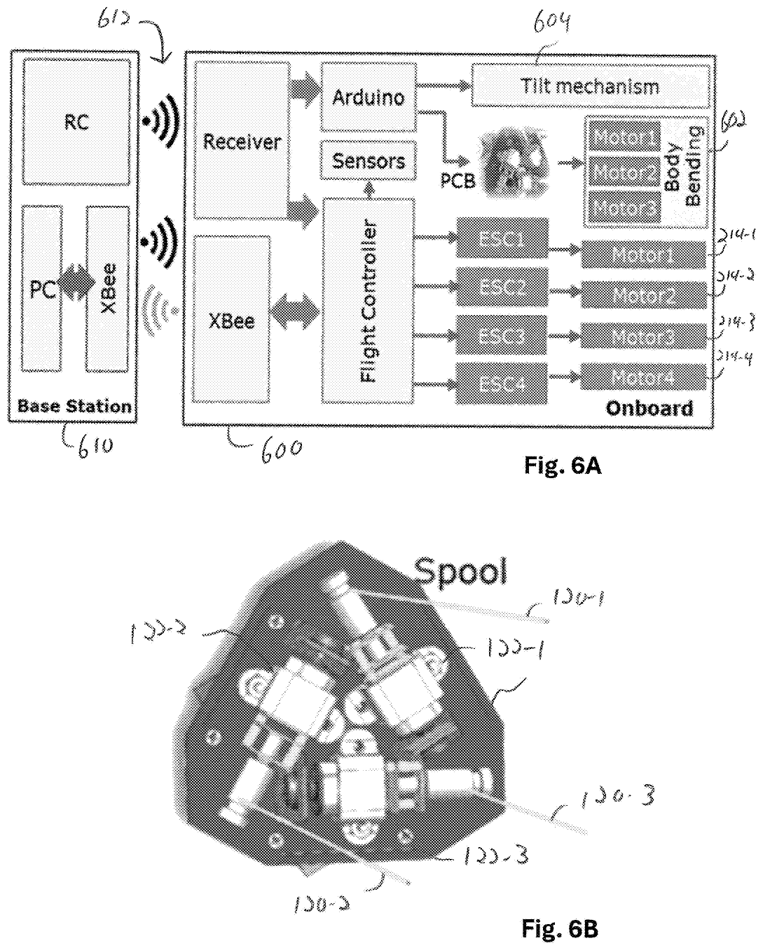

FIGS. 6A-6B shows diagrams of the control mechanisms in the robot of FIGS. 4A-5D. FIG. 6A shows a control system block diagram depicting the bending control of the morphing fuselage and tilt mechanisms. An on-board flight controller 600 allows the aerial robot 200 to remain in steady level flight under closed-loop control from a wifi/wireless link 612 with a ground station 610, which commands body bending 602, tilt 604 wing mechanisms, and throttle for controlling motor 214 speed. Body bending 602 results from control of the antagonist members 120 further comprise linear actuators or cables responsive for extending or contracting the elongated body 101 along the respective tether. FIG. 6B shows an example retractor arrangement with actuation sources 122-1 . . . 122-3 disposed on a cross sectional segment 110 for retracting tethers defining the antagonist members 120-1 . . . 120-3.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A robotic device, comprising:
a plurality of cross sectional segments, the cross sectional segments aligned along a central axis, each cross sectional segment of the plurality of cross sectional segments having a flexible linkage to an adjacent cross sectional segment;
a plurality of antagonistic members extending through the cross sectional segments at a parallel offset to the central axis, the antagonistic members configured for extension or contraction; and
an actuation source driving the antagonistic members in independent movement, the actuated movement of one or more of the antagonistic members disposing the cross sectional segments out of a parallel alignment.

2. The device of claim 1 wherein the cross sectional segments defined by a planar shape, each planar shape parallel to the planar shape of the others of the plurality of cross sectional segments at a rest position, the parallel planar shapes defining an elongated body.

3. The device of claim 1 wherein the cross sectional segments form a tubular circumference, the segments defined by folds between adjacent cross sectional segments, the folds forming a continuous tubular structure defining an elongated body.

4. The device of claim 2 wherein unequal movement of the antagonistic members forms an arcuate shape of the elongated body and offset from the central axis.

5. The device of claim 2 wherein extension of the antagonistic members in an equal amount increases a length of the elongated body while maintaining alignment with the central axis.

6. The device of claim 2 wherein contraction of the antagonistic members in an equal amount decreases a length of the elongated body while maintaining alignment with the central axis.

7. The device of claim 1 further comprising a pivotal linkage between each of the cross sectional segments and an adjacent cross sectional segment, each of the linkages aligned with the central axis.

8. The device of claim 2 further comprising one or more robotic members extending from the elongated body, each of the robotic members having a motor unit, the motor unit configured for propulsion of the elongated body.

9. The device of claim 2 further comprising one or more robotic members extending from the elongated body, each of the robotic members having a control surface configured for fluidic engagement and directional control of the elongated body.

10. The device of claim 2 further comprising a motive source connected to the elongated body, the motive source configured for propulsion of the elongated body in a direction based on the extension or retraction of the antagonistic members.

11. The device of claim 1 wherein the cross sectional segments are each defined by a resilient material, the flexible linkage defined by a protrusion of the resilient material.

12. The device of claim 1 wherein the cross sectional segments are polygonal and linked at the central axis to an adjacent cross sectional segment.

13. The device of claim 1 wherein the antagonistic members further comprise tethers responsive to a motive rotational retraction for compressing the elongated body along the respective tether.

14. The device of claim 1 wherein the antagonistic members further comprise fluidic vessels responsive to a pressure source for extending the elongated body along the respective vessel.

15. The device of claim 1 wherein the antagonist members further comprise linear actuators responsive for extending or contracting the elongated body along the respective tether.

16. The device of claim 1 wherein the cross sectional segments are planar polygonal or circular shapes.

17. A method of forming a robot, comprising:
aligning a plurality of cross sectional segments, the cross sectional segments aligned along a central axis, each cross sectional segment of the plurality of cross sectional segments having a flexible linkage to an adjacent cross sectional segment;
extending a plurality of antagonistic members through each of the cross sectional segments at a parallel offset to the central axis, the antagonistic members configured for extension or contraction; and
engaging each of the antagonistic members with an actuation source for independent movement, the actuated movement of one or more of the antagonistic members disposing the cross sectional segments out of a parallel alignment.

18. A method of operating a robot, comprising:
forming an elongated body along a central axis, the elongated body formed from a flexible material for deformable movement offset from the central axis;
extending a plurality of antagonistic members through the elongated body at a parallel offset to the central axis, the antagonistic members configured for extension or contraction;
engaging each of the antagonistic members with an actuation source for independent movement, the actuated movement of one or more of the antagonistic members disposing the elongated body out of alignment with the central axis; and
manipulating the plurality of antagonistic members to an unequal length for deforming the elongated body at an angle to the central axis.
